(19) United States
(12) Patent Application Publication
(10) Pub. No.: US 2016/0264007 A1
(43) Pub. Date: Sep. 15, 2016

(54) Wireless Vehicle Battery Charging System

(71) Applicant: Micah Haase, Culbertson, MT (US)

(72) Inventor: Micah Haase, Culbertson, MT (US)

(21) Appl. No.: 15/065,238

(22) Filed: Mar. 9, 2016

Related U.S. Application Data
(60) Provisional application No. 62/130,667, filed on Mar. 10, 2015.

(51) Int. Cl. B60L 11/18

(52) U.S. Cl. CPC B60L 11/182; B60L 11/1861

(57) ABSTRACT

A wireless vehicle battery charging system. The wireless vehicle battery charging system includes a supply pad having a control circuit electrically connected to a power source. A receiver pad is mounted to an underside of a vehicle and electrically connected to a vehicle battery. The receiver pad and supply pad each include sensors. The supply pad sensor is configured detect the presence of the receiver pad sensor when it is positioned above the supply pad sensor. The control circuit is configured to wirelessly transmit power to the receiver pad via resonant inductive coupling between the supply pad and receiver pad when the supply pad sensor detects the receiver pad sensor. The receiver pad is configured to charge the vehicle battery via the power received from the supply pad.

### CROSS REFERENCE TO RELATED APPLICATIONS

This application claims the benefit of U.S. Provisional Application No. 62/130,667 filed on Mar. 10, 2015. The above identified patent application is herein incorporated by reference in its entirety to provide continuity of disclosure.

### BACKGROUND OF THE INVENTION

The present invention relates to wireless battery charging systems. More specifically, the present invention relates to wireless battery charging systems for wirelessly charging a vehicle battery.

Cars, trucks, and other types of vehicles typically utilize a battery for powering electrical systems such as lighting and for providing energy for starting the vehicle engine. Once the vehicle engine is running, power is supplied to the electrical systems via an alternator, which also recharges the vehicle battery. However, the alternator only recharges the battery when the vehicle engine is running. When a vehicle engine has not run for long periods of time, the battery slowly loses charge. If a vehicle sits unused long enough, the battery will be so depleted that the vehicle will be unable to start. An individual typically must then utilize jumper cables and another vehicle to recharge the battery. This can be a time consuming and inconvenient process and can be difficult to achieve. Further, this method of recharging a vehicle battery is only possible if the individual has access to a second vehicle. Therefore, it is desirable to provide a system for maintaining the charge of a vehicle battery when the vehicle experiences extended periods of nonuse.

Prior art devices for charging a vehicle battery while the engine is not running are known. However, these prior art devices utilize a wired connection between the vehicle battery and a wall outlet. Individuals must connect the charger to the vehicle battery, which can be difficult and even dangerous due to accidental discharges. An extension cord may be required to reach from the vehicle battery to a wall outlet. Further, the charging cable must be disconnected before the vehicle can be used, which causes added inconvenience to the user. Therefore, there is need for a vehicle battery charging system that wirelessly recharges a vehicle battery.

Wireless charging is typically accomplished via inductive charging. Inductive charging utilizes an electromagnetic field to transfer energy between two objects. Induction chargers utilize a charging base having a first induction coil. The device to be charged has a second induction coil operatively connected to an energy storage such as a battery. When the first and second coils are in close proximity to one another, an electrical transformer is formed, which transfers electrical energy from the first coil to the second coil via electromagnetic induction.

One drawback to traditional inductive charging is that the two coils must be in very close proximity to one another in order for electrical energy to be transferred between the coils. However, wireless transmission of energy may also be accomplished via resonant inductive coupling, which is the near field wireless transmission of electrical energy between two magnetically coupled coils that are part of resonant circuits tuned to resonate at the same frequencies, which is accomplished via oscillation of the circuit. Resonant inductive coupling allows for transmission of energy within a distance a few times larger than that of both objects involved in the transfer. In this way, energy can be transferred between a wireless source device and a receiver with an acceptable efficiency and minimized energy loss. It is therefore desirable to provide a wireless vehicle battery charging system that utilizes resonant inductive magnetic coupling to transfer energy from a supply pad to a receiver pad mounted on a vehicle.

### SUMMARY OF THE INVENTION

In view of the foregoing disadvantages inherent in the known types of vehicle battery charging systems now present in the prior art, the present invention provides a wireless vehicle battery charging system wherein the same can be utilized for providing convenience for the user when utilizing wireless transmission of power to maintain a vehicle battery at a constant voltage when the vehicle is not in use. The wireless vehicle battery charging system includes a supply pad that has a housing and a first induction coil disposed in the housing. The supply pad is connected to a power source and is configured to wirelessly transmit the electrical energy provided by the power source. A receiver pad is in operable communication with a vehicle battery, and includes a housing and a second induction coil disposed in the housing. The receiver pad housing is securable to an underside of a vehicle, is configured to receive wirelessly transmitted electrical energy. The first induction coil and second induction coil are in wireless electrical communication via resonant inductive magnetic coupling, and the receiver pad is configured to transmit electrical energy received from the supply pad to the vehicle battery. This allows users to maintain a vehicle's battery at a constant voltage.

One object of the present invention is to provide a wireless vehicle battery charging system having all of the advantages of the prior art systems and none of the disadvantages.

Another object of the present invention is to provide a wireless vehicle battery charging system having an indicator light that indicates whether the vehicle battery is currently being charged.

A further object of the present invention is to provide a wireless vehicle battery charging system capable of automatically charging a vehicle battery without user intervention.

Yet another object of the present invention is to provide a wireless vehicle battery charging system having a sensor disposed on a supply pad and a sensor disposed on receiver pad, where the sensors are configured to detect one another's presence in order to commence wireless charging.

Still a further object of the present invention is to provide a wireless vehicle battery charging system that is configured to cease charging the vehicle battery when the vehicle battery reaches a threshold voltage.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a wireless vehicle battery charging system according to the present invention secured to a vehicle.

FIG. 2 shows a schematic view of the electronic components of a wireless vehicle battery charging system according to the present invention.

FIG. 3 shows a side view of a wireless vehicle battery charging system according to the present invention in use to charge a vehicle battery.

### DETAILED DESCRIPTION OF THE INVENTION

Reference is made herein to the attached drawings. Like reference numerals are used throughout the drawings to depict like or similar elements of the wireless vehicle battery charging system. For the purposes of presenting a brief and clear description of the present invention, the preferred embodiment will be discussed as used for wirelessly transmitting power from a supply pad to a receiver pad mounted on a vehicle in order to charge the vehicle battery. The figures are intended for representative purposes only and should not be considered to be limiting in any respect.

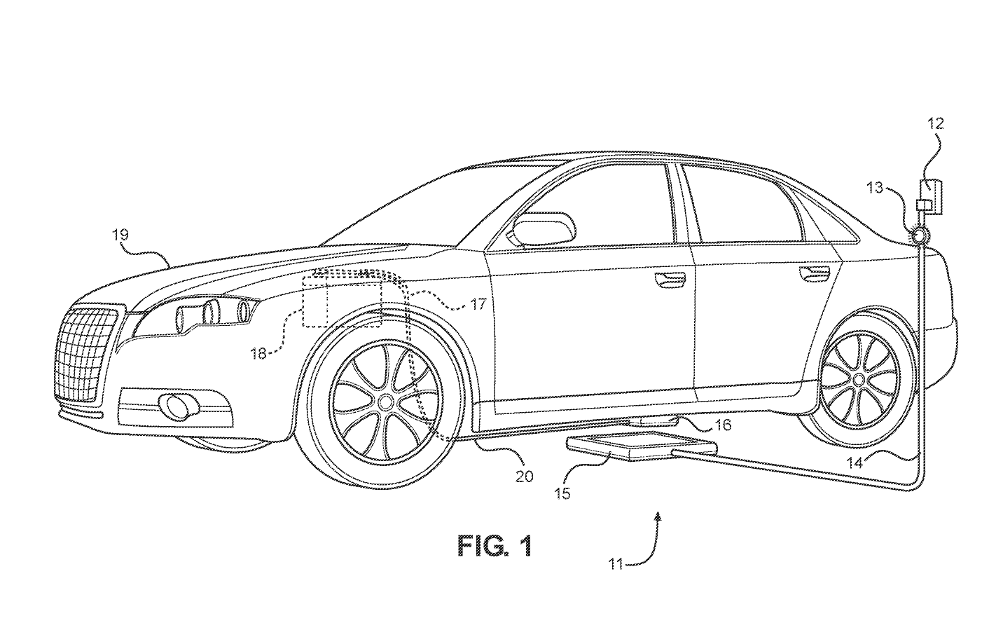

Referring now to FIG. 1, a perspective view of a wireless vehicle battery charging system according to the present invention is shown secured to a vehicle. The wireless vehicle battery charging system 11 generally comprises a supply pad 15 configured to transmit wireless power and receiver pad 16 configured to receive wireless power transferred from the supply pad 15. The supply pad 15 rests on a ground surface during use. The supply pad 15 comprises a weatherproof housing in order to prevent moisture from damaging the electronic components of the supply pad 15.

The supply pad 15 is electrically connected to a power supply such as a power outlet 12 in a home or garage via a power cable 14. In one embodiment, an indicator light 13 is disposed on the power cable 14. The indicator light 13 is configured to illuminate when the supply pad 15 transmits power to the receiver pad 16. The indicator light 13 is further configured to remain unlit when the supply pad 15 is not wirelessly transmitting power to the receiver pad 16. In the illustrated embodiment, the indicator light 13 is disposed on the power cable 14 adjacent to the wall outlet 12. Individuals may glance at the wall outlet 12 to which the power cable 14 is connected in order to determine whether the supply pad 15 is transmitting power to the receiver pad 16.

In some instances, the wall outlet 12 to which the power cable 14 is connected is not easily visible. In alternate embodiments, the indicator light 13 is disposed on the power cable 14 a further distance from the power outlet, so that the indicator light 13 rests on the ground. This allows users to look downward at the indicator light 13 to observe whether the supply pad 15 is currently transmitting power to the receiver pad 16.

The receiver pad 16 is secured to the underside of a vehicle 19 via one or more fasteners. The receiver pad 16 further comprises a waterproof housing so that the electronic components of the receiver pad 16 are protected from rain and other moisture that may cause damage to the receiver pad 16.

The receiver pad 16 is electrically connected to the vehicle battery 18 via an electrical connector 17. In one embodiment, a lower portion 20 of the electrical connector may be run underneath the chassis of the vehicle 19 and enter the engine bay in order to connect to the vehicle battery 18. Alternatively, the electrical connector 17 may be hidden within the engine compartment of the vehicle 19 in order to prevent the electrical connector 17 from being damaged by elements outside of the vehicle 19 such as ice, road debris, water, and the like.

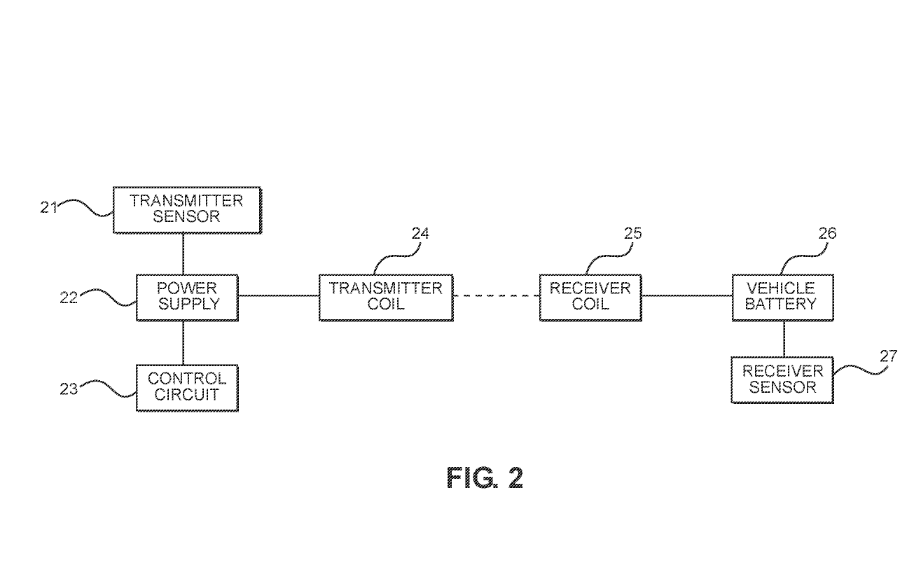

Referring now to FIG. 2, a schematic view of the electronic components of a wireless vehicle battery charging system according to the present invention is shown. The mechanism for transmitting wireless power from the supply pad is a transmitter coil 24, which is configured to be inductively coupled with a receiver coil 25 disposed within the supply pad. Each of the transmitter coil 24 and receiver coil 25 are configured to oscillate at the same resonant frequency, which provides for resonant inductive coupling between the transmitter coil 24 and receiver coil 25. The transmitter coil 24 wirelessly transmits electric power while the receiver coil 25 receives the electric power and transmits it to the vehicle battery 26. The supply pad connects to a power supply 22 such as a wall outlet which provides power to the transmitter coil 24.

The transmitter coil 24 is in operative communication with a transmitter sensor 21, and the receiver coil 25 is in operative communication with a receiver sensor 27. The transmitter sensor 21 is configured to detect the presence of the receiver sensor 27. In one embodiment, the sensors 21, 27 are optical sensors configured to detect the visual presence of one another. When the transmitter sensor 21 detects the presence of the receiver sensor 27, a control circuit 23 in operative communication with the transmitter coil 24 is configured to cause the transmitter coil 24 to wirelessly transfer electrical power to the receiver coil 25. The control circuit 23 is further configured to cease the transmission of energy via the transmitter coil 24 when the vehicle battery 26 reaches a threshold voltage. For example, the control circuit 23 may be configured to cease transmission of electrical power when the vehicle battery 26 is at 12 volts, which is the standard operating voltage of a typical vehicle battery 26.

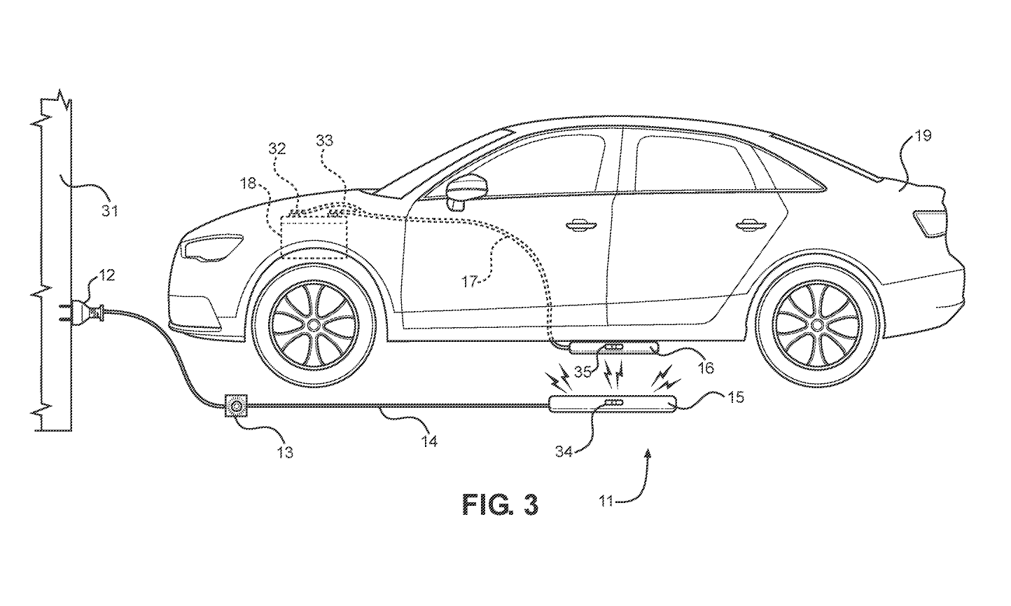

Referring now to FIG. 3, a side view of a wireless vehicle battery charging system according to the present invention is shown in use to charge a vehicle battery. In this embodiment, the indicator light 13 is positioned along the power cable 14 such that it rests on a ground surface during use. This allows individuals in the vehicle 19 to glance downward and determine whether the vehicle battery 18 is currently being charged. Further, the power source 12 to which the power cable 14 is connected is disposed on a wall 31 such as a garage wall or a wall of a home.

In the illustrated embodiment, a transmitter sensor 34 is disposed on the housing of the supply pad 15, and a receiver sensor 35 is disposed on the housing of the receiver pad 16. The transmitter sensor 34 detects the presence of the receiver sensor 35 when it is positioned above the transmitter sensor 34. When detection occurs, the supply pad 15 wirelessly transmits power to the receiver pad 16, which in turn transfers the electrical power to the vehicle battery 18 via the electrical connector 17. The electrical connector 17 splits into a negative connector 32 which connects to the negative terminal of the vehicle battery 18 and a positive connector 33 which connects to the positive terminal of the vehicle battery 18.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless vehicle battery charging system, comprising:
a supply pad comprising a housing having a first induction coil disposed therein, wherein the supply pad connected to a power source, and wherein the supply pad configured to wirelessly transmit electrical energy;
a receiver pad in operable communication with a vehicle battery, the receiver pad comprising a housing having a second induction coil disposed therein, wherein the receiver pad housing is securable to an underside of a vehicle, and wherein the receiver pad is configured to receive wirelessly transmitted electrical energy;
wherein the first induction coil and second induction coil are in wireless electrical communication via resonant inductive magnetic coupling; and
wherein the receiver pad is configured to transmit electrical energy received from the supply pad to the vehicle battery to maintain the vehicle battery at a constant voltage.

2) The wireless vehicle battery charging system of claim 1, wherein the power source is a wall outlet, and wherein the supply pad is connected to the wall outlet via a cable.

3) The wireless vehicle battery charging system of claim 1, wherein the supply pad housing and receiver pad housing are each configured to be waterproof.

4) The wireless vehicle battery charging system of claim 2, further comprising:
an indicator light disposed on the cable;
wherein the indicator light is configured to illuminate upon a transfer of energy from the supply pad to the receiver pad; and
wherein the indicator light further configured to cease illumination upon cessation of the transfer of energy from the supply pad to the receiver pad.

5) The wireless vehicle battery charging system of claim 1, further comprising:.
a first sensor disposed on the supply pad;
a second sensor disposed on the receiver pad;
wherein the first sensor is configured to detect the second sensor when the second sensor is positioned above the first sensor; and
wherein the supply pad is configured to transmit electrical energy to the receiver pad when the first sensor detects the presence of the first sensor.

6) The wireless vehicle battery charging system of claim 4, wherein the first sensor and second sensors are each optical sensors.

7) The wireless vehicle battery charging system of claim 1, further comprising:
a control circuit disposed within the supply pad housing;
wherein the control circuit is configured to detect the voltage level of the vehicle battery and cease transmission of energy when the vehicle battery when the voltage is above a threshold amount.

8) The wireless vehicle battery charging system of claim 6, wherein the threshold amount is greater than or equal to twelve volts.

9) The wireless vehicle battery charging system of claim 1, further comprising:
an electrical connector that connects the vehicle battery to the receiver pad, the electrical connector comprising a first end securable to the receiver pad, a positive end securable to a positive terminal of the vehicle battery, and a negative end securable to a positive terminal of the vehicle battery.

10) A wireless vehicle battery charging system, comprising:
a vehicle having a lower surface and a vehicle battery;
a supply pad secured to the lower surface of the vehicle, the supply pad comprising a first induction coil connected to a power source, wherein the supply pad is configured to wirelessly transmit electrical energy;
a receiver pad having a second induction coil securable to the lower surface of the vehicle, wherein the receiver pad is configured to receive wirelessly transmitted electrical energy, and wherein the receiver pad is in operable communication with the vehicle battery;
wherein the first induction coil and second induction coil are in operable communication via resonant inductive magnetic coupling; and
wherein the receiver pad is configured to transmit energy received from the supply pad to the vehicle battery to maintain the vehicle battery at a constant voltage.
